(19) United States
(12) Patent Application Publication
(10) Pub. No.: US 2014/0122157 A1
(43) Pub. Date: May 1, 2014

(54) CALENDAR FEATURE FOR CREATING A TRIP OBJECT

(71) Applicants: Carsten Schmitt, Walldorf (DE); Tina Marseille, Walldorf (DE)

(72) Inventors: Carsten Schmitt, Walldorf (DE); Tina Marseille, Walldorf (DE)

(21) Appl. No.: 13/661,380

(22) Filed: Oct. 26, 2012

(51) Int. Cl. G06Q 10/06

(52) U.S. Cl. 705/7.24

(57) ABSTRACT

Display data to cause the display of a calendar feature having one or more date elements may be output. A selection of a date element or date elements and user input for creating a trip object may be received. The trip object may be created in response and the start and end fields for the trip object may be populated based on the selected date elements.

### BACKGROUND

Travel planning, including travel approvals, bookings, and expense reporting may be time dependant. In some implementations, the travel information is presented in a tabular format that may not necessarily be intuitive and/or natural to how business travelers perceive time. Instead, travelers may prefer to view and sort the various trips in a visual manner, such as when planning ahead or finishing past trips.

### SUMMARY

One implementation relates to a method for creating a business trip that may include outputting display data to effect display of an interactive calendar feature having one or more date elements. Data indicative of a selection of one or more date elements of the interactive calendar feature and data indicative of a user input for creating a trip object may be received. The trip object may be created in response to the received user input. A start date field of the trip object may be populated with a first date corresponding to a first date element of the selected one or more date elements, and an end date field of the trip object may be populated with a second date corresponding to a second date element of the selected one or more date elements in response to the trip object being created.

Another implementation relates to a tangible computer-readable storage medium having instructions to create a business trip that may include instructions to output display data to effect display of an interactive calendar feature having one or more date elements. A first date element may be associated with a first trip object having a first attribute. Display data to effect display of a first visual indicator associated with the first attribute for the first date element may be output. Data indicative of a selection of one or more date elements of the interactive calendar feature may be received. A second trip object may be created if the selected one or more date elements do not include the first date element. A start date field of the second trip object may be populated with a first date corresponding to a start date element of the selected one or more date elements, and an end date field of the second trip object may be populated with a second date corresponding to an end date element of the selected one or more date elements in response to the second trip object being created.

A further implementation relates to a system having a tangible computer-readable storage device having instructions and one or more processors configured to execute the instructions to perform several operations. The operations may include outputting display data to effect display of an interactive calendar feature having one or more date elements. Data indicative of a selection of one or more date elements of the interactive calendar feature and of a user input may be received. A trip object may be created in response to the received user input. A start date field of the trip object may be populated with a first date corresponding to a first date element of the selected one or more date elements, and an end date field of the trip object may be populated with a second date corresponding to a second date element of the selected one or more date elements in response to the trip object being created. Display data to effect display of a visual indicator for the one or more date elements may be output. In response to data indicative of a placement of a cursor for at least a predetermined amount of time over a portion of a computer display corresponding to the one or more date elements, display data to effect display of a textual indicator may be output.

### BRIEF DESCRIPTION OF THE DRAWINGS

Various embodiments taught herein are illustrated by way of example, and not by way of limitation, in the figures of the accompanying drawings, in which:

FIG. 1 is a block diagram of an example computing device;

FIG. 2 is a block diagram of a system having a plurality of computing devices connected to a server via a network;

FIG. 3 is a flow diagram of an example method for creating a trip object using an interactive calendar feature;

FIG. 4 is a depiction of an example user interface having an interactive calendar feature; and

FIG. 5 is a depiction of the interactive calendar feature of FIG. 4 showing an example displayed textual indicator.

It will be recognized that some or all of the figures are schematic representations for purposes of illustration. The figures are provided for the purpose of illustrating one or more embodiments with the explicit understanding that they will not be used to limit the scope or the meaning of the claims.

### DETAILED DESCRIPTION

The following is merely provided for example purposes with the explicit understanding that the examples described herein will not be used to limit the scope or the meaning of the claims.

As noted above, travelers may prefer to view and sort the various trips in a visual manner in some instances. In one implementation, an interactive calendar feature may be provided to permit a user to easily find and create business trips in a more familiar form. In some implementations, the interactive calendar feature may be placed next to a tabular view of a list of business trips to show which trips have occurred and/or will occur on the relevant dates. The interactive calendar feature may also be used by a user to select a particular date or date range and creating a trip, i.e. creating a formal approval document, booking a trip, and/or creating an expense report that applies to the dates selected. Thus, travelers may be able to more easily integrate the planning and creating of a trip using the visual context provided by the interactive calendar feature. In some instances, such as when a person is planning trips for another individual, the visual depiction of the various trips may be useful instead of reviewing a tabular set of trips. Moreover, in some instances, a user may save time and/or may avoid erroneous creation of overlapping business trips through the use of an interactive calendar feature that visually depicts the various business trips.

In some instances, the creation of a trip business object, such as a travel request form or an expense report, may also automatically associate a start and/or end date when selected from the calendar. For example, a user may highlight one or more dates of the calendar and, through a secondary action (e.g., a right click, selecting a button, etc.), a new trip object may be created. In some instance, the new trip object may only be created if no other trip objects are associated with the selected dates, such as to avoid creating overlapping trips. In still other versions, the trip business object may be automatically created once the dates are selected.

In some implementations, the various trip business objects may be identified by a visual indicator, such as by different colors. The different visual indicia may be used to differentiate kinds of trips and/or trips statuses and/or stages (e.g., trip requests, expense reports, and/or the like). In yet further implementations, a user may point a cursor at a date that is marked for a trip and a textual indicator (such as a text bubble, a “tool tip,” and/or the like) may be displayed in response that shows a trip name, a trip identifier, a trip purpose, and/or other information related to the trip business object. If a user selects a date that a trip business object is associated with, then the trip business object and/or other features may be opened to be inspected and/or edited by the user.

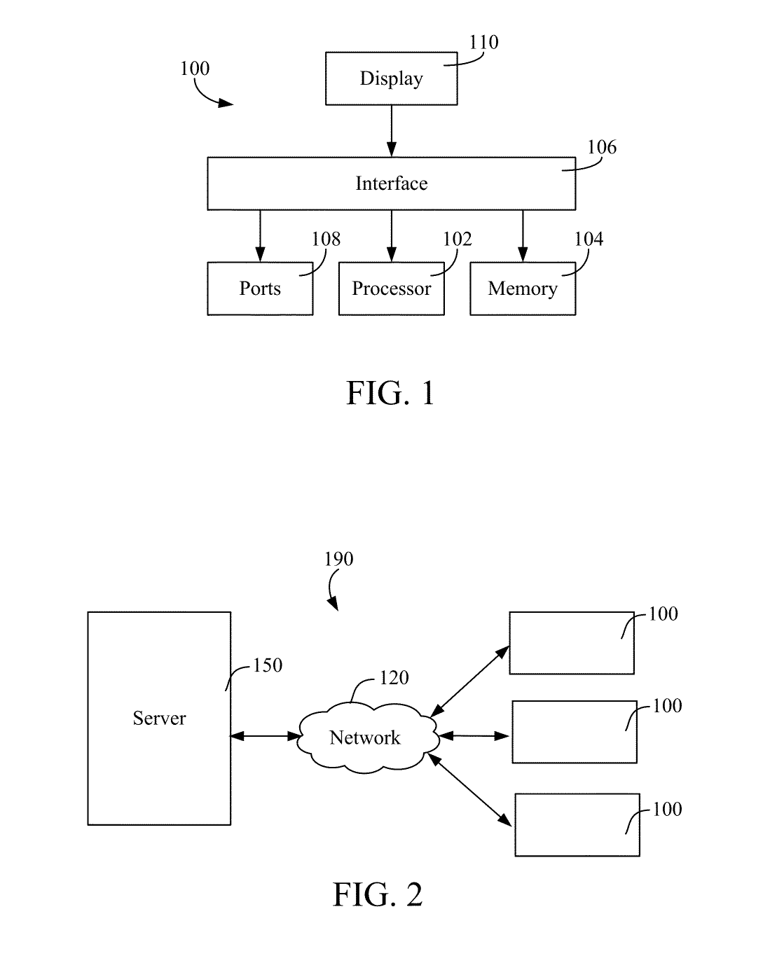

FIG. 1 is a block diagram of a computing device 100 that may be used to implement the systems and methods in accordance with the implementations described herein, as either a client or as a server or plurality of servers. Computing device 100 may include, but is not limited to, digital computers, such as laptops, desktops, workstations, personal digital assistants, servers, blade servers, mainframes, cellular telephones, smart phones, mobile computing devices (e.g., a notepad, e-reader, tablet, netbook, etc.), etc.

Computing device 100 includes a processor 102, memory 104, an interface 106 and ports 108. Each of the components 102, 104, 106, and 108, are interconnected using various busses, and may be mounted on a common motherboard or in other manners as appropriate. The processor 102 can process instructions for execution within the computing device 100, including instructions stored in the memory 104 to display graphical information for a GUI on an external input/output device, such as display 110 coupled to interface 108.

In other implementations, multiple processors and/or multiple buses may be used, as appropriate, along with multiple memories and types of memory. Also, multiple computing devices 100 may be connected, with each device providing portions of the necessary operations (e.g., as a server bank, a group of blade servers, a multi-processor system, etc.). The ports 108, which may include various communication ports (e.g., USB, Bluetooth, Ethernet, wireless Ethernet, etc.), may be coupled to one or more input/output devices, such as a keyboard, a mouse, a pointing device, a scanner, etc., or a networking device (a switch, adapter, bridge, router, hub, repeater, etc.).

The processor 102 may provide, for example, for coordination of the other components of the device 100, such as control of user interfaces, applications run by device 100, and wireless communication by device 100. Processor 102 may communicate with a user via interface 106 (e.g., control, display, external, etc.), coupled to a display 110. The display 110 may be, for example, a TFT (Thin-Film-Transistor Liquid Crystal Display) display, an OLED (Organic Light Emitting Diode) display, other flexible display, etc. The interface 106 may include circuitry for driving the display 110 to provide graphical, textual, and other information to a user. The interface 106 may receive commands (e.g., voice-activated, text, etc.), from a user and convert them to provide to the processor 102.

In addition, the interface 106 may be provided to communicate with processor 102 and enable near area communication of device 100 with other devices. The interface 106 may provide, for example, for wired communication. In some implementations, multiple interfaces may be used. Computing device 100 may communicate wirelessly through interface 106, which may include digital signal processing circuitry where necessary. Interface 106 may provide for communications under various modes or protocols, such as GSM voice calls, SMS, EMS, or MMS messaging, CDMA, TDMA, PDC, WCDMA, CDMA2000, or GPRS, etc. Such communication may occur, for example, through a radio-frequency transceiver. In addition, short-range communication may occur, such as using a Bluetooth, WiFi, or other such transceiver. In addition, GPS (Global Positioning System) receiver module may provide additional navigation- and location-related wireless data to device 100, which may be used as appropriate by applications running on device 100. The device 100 may also be provided with a storage device to provide additional storage, e.g., solid-state flash media. Each of the components may be interconnected using various buses. Several of the components may be mounted on a common motherboard or in other appropriate manners.

The memory 104 stores information within the computing device 100. In one implementation, the memory 104 is a volatile memory unit or units. In another implementation, the memory 104 is a non-volatile memory unit or units. In yet another, the memory 104 comprises both volatile memory units and non-volatile memory units. The memory 104 may also be another form of computer-readable medium, such as a magnetic or optical disk. The memory 104 may be capable of providing mass storage for the computing device 100. In one implementation, the memory 104 may be or contain a computer-readable medium, such as a floppy disk, CD-ROM, DVD, magnetic disk, memory chip, ROM, RAM, EEPROM, EPROM, flash memory or other similar solid state memory device, or an array of devices, including devices in a storage area network or other configurations.

A computer program product may be tangibly embodied in an information carrier. The computer program product may also contain instructions that, when executed, perform one or more methods, such as those described below. The information carrier is a computer or machine-readable medium, such as the memory 104, memory on processor 102, etc. Expansion memory may be provided and connected to device 100 through interface 106. The processor 102 and memory 104 may form a processing circuit or module.

Referring to FIG. 2, in some versions, a plurality of computing devices 100 may be connected to one or more servers 150 via a network 120 to form a system 190. Network 120 may be any form of computer network that relays information between computing devices 100 and server 150. For example, network 120 may include the Internet and/or other types of data networks, such as a local area network (LAN), a wide area network (WAN), a cellular network, satellite network, or other types of data networks. Network 120 may also include any number of computing devices (e.g., computer, servers, routers, network switches, etc.) that are configured to receive and/or transmit data within network 120. Network 120 may further include any number of hardwired and/or wireless connections. For example, computing devices 100 may communicate wirelessly (e.g., via WiFi, cellular, radio, etc.) with a transceiver that is hardwired (e.g., via a fiber optic cable, a CATS cable, etc.) to other computing devices in network 120.

Server 150 may also be any number of different types of electronic devices configured to communicate via network 120 (e.g., a laptop computer, a desktop computer, a tablet computer, a smart phone, a server, combinations thereof, etc.). Server 150 may be configured in substantially the same way as computing device 100 or server 150 may have other configurations. Server 150 may include a processor and a memory, i.e., a processing circuit or module. The memory may store machine instructions that, when executed by the processor cause the processor to perform one or more of the operations described herein. The processor may include a microprocessor, ASIC, FPGA, etc., or combinations thereof. The memory may include, but is not limited to, electronic, optical, magnetic, or any other storage or transmission device capable of providing the processor with program instructions. The memory may include a floppy disk, CD-ROM, DVD, magnetic disk, memory chip, ROM, RAM, EEPROM, EPROM, flash memory, optical media, or any other suitable memory from which the processor can read instructions.

In some versions, system 190 may be implemented and/or integrated into an enterprise architecture. Of course, system 190 is merely an example and other systems may be used with the methods and processes described herein.

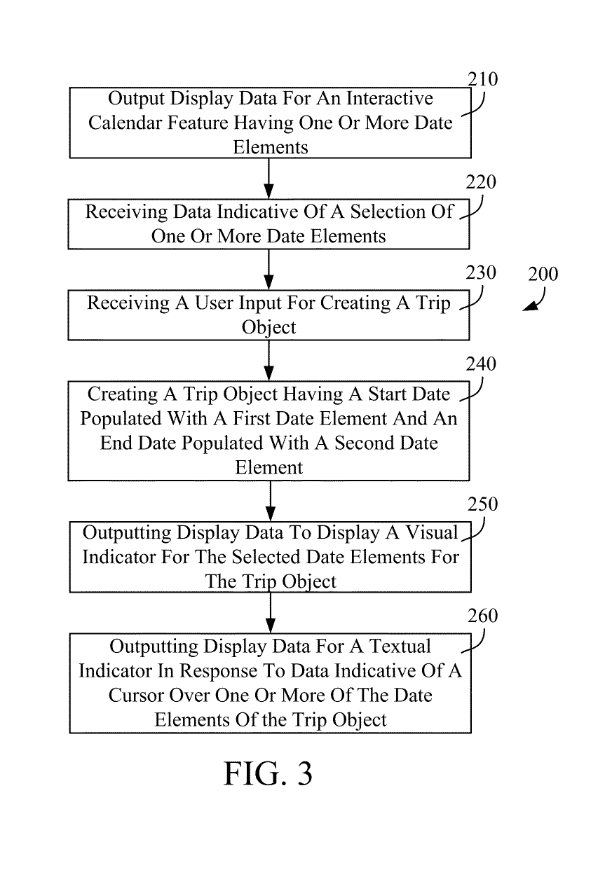

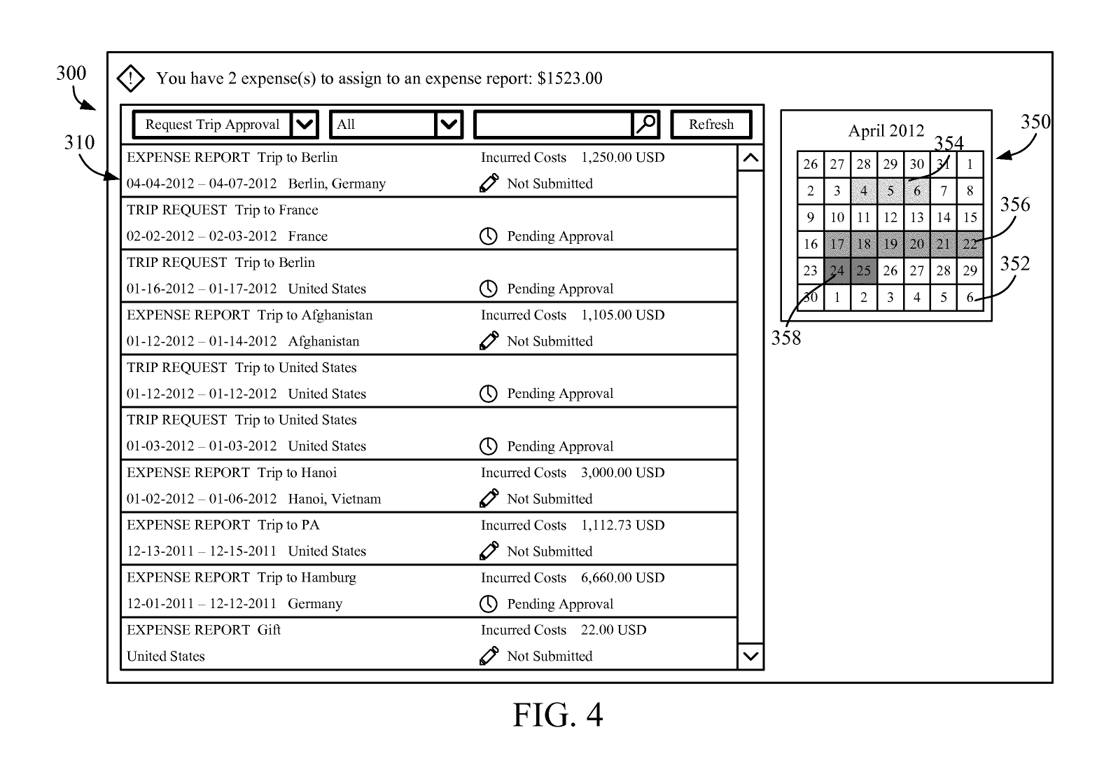

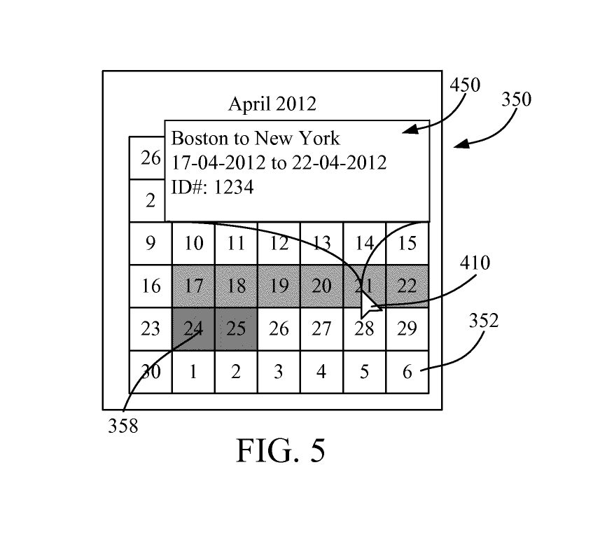

FIG. 3 depicts an example method 200 for creating a trip object using an interactive calendar feature. Display data for an interactive calendar feature, such as calendar feature 350 shown in FIGS. 4-5, having one or more date elements may be output (step 210). In some implementations, the calendar feature may be displayed as part of a user interface and proximate to a list or other representation of trip objects (such as a list of trips, expense reports, trip requests, and/or the like). In some implementations, the calendar feature may include a single date element (such as a single day) or multiple date elements (e.g., a work-week calendar having five date elements, a weekly calendar having seven date elements, a monthly calendar having a set of date elements corresponding to the number of days in that month, and/or multiple months having a set of date elements corresponding to the number of days in the multiple months). In some instances, one or more trip objects may be associated with one or more of the date elements. For example, a trip object may be associated with the date elements that are representative of April 4 through April 6. The display data for the calendar feature may include a visual indicator for the date elements associated with the trip object such that the displayed date elements provide a visual indication to a user that a trip is associated with those dates which the date elements represent. By way of example only, the visual indicator may include a color and/or shading for the date elements, such as the visual indicator 360 shown in FIG. 4. In other implementations, other visual indicators may be provided, such as an icon, a symbol, and/or the like. The visual indicator may be associated with an attribute of the trip object. For example, the visual indicator may vary based on the status of the trip (e.g., a certain color for trips that are currently in the trip request stage and/or a different color for trips in the expense reporting stage, a certain color for trips that are currently in the draft status of the trip request stage and/or a different color for trips in the approved status of the trip request stage, etc.). In some other implementations, the visual indicators may vary based on a type of trip (e.g., international trips, local trips, marketing trips, accounting trips, etc.). Thus, a first visual indicator associated with a first attribute of a first trip object and a second visual indicator associated with a second attribute of a second trip object may be used by a user to quickly distinguish trip objects based on status, type, and/or any other attribute of the trip object (e.g., requested trip cost, location, etc.).

Data indicative of a selection of one or more date elements of the calendar feature may be received (step 220). For example, a user may highlight date elements of the calendar feature by clicking on a first date element and dragging the selection through one or more additional date elements. In other implementations, a user may select a first date element (e.g., April 4) and a second date element (e.g., April 6) and any date elements in between (e.g., April 5) may be included in the selection as well. It should be understood that a single date element may be selected as well.

A user input may be received for creating a trip object (step 230). For instance, the user input may include a secondary action, such as clicking a right mouse button, selecting a creation button, pressing a key, and/or a combination thereof. In some other implementations, the trip object may be automatically created upon the selection of the one or more date elements as described above.

A trip object may be created having a start date field populated with a first date element and an end date field populated with a second date element (step 240). For example, the start date of the created trip object may be populated with a first selected date of April 4 and an end date may be populated with a second selected date of April 6. In instance, the first and second date elements may be the same date (e.g., a single day trip object) such that both the start and end date are the same. In some implementations, a user interface may be provided to a user for modifying, editing, and/or otherwise interacting with the created trip object. For example, the user interface may be automatically provided after creating the trip object. In some implementations, the user interface may be a separate page and/or a window having one or more fields for entering information about the trip object (e.g., for a trip request, the proposed location, cost, etc.). Of course other user interfaces and/or other ways of modifying the trip object may be provided as well.

Display data may be output to display a visual indicator for the selected date elements for the trip object (step 250). Once the trip object is created, a visual indicator may be displayed for the date elements of the calendar feature that are associated with the created trip object. By way of example only, the visual indicator may include a color and/or shading for the date elements, such as the visual indicator 360 shown in FIG. 4. In other implementations, other visual indicators may be provided, such as an icon, a symbol, and/or the like. The visual indicator may be associated with an attribute of the trip object. For example, the visual indicator may vary based on the status of the trip (e.g., a certain color for trips that are currently in the trip request stage and/or a different color for trips in the expense reporting stage, a certain color for trips that are currently in the draft status of the trip request stage and/or a different color for trips in the approved status of the trip request stage, etc.). In some other implementations, the visual indicators may vary based on a type of trip (e.g., international trips, local trips, marketing trips, accounting trips, etc.). Thus, a first visual indicator associated with a first attribute of a first trip object and a second visual indicator associated with a second attribute of a second trip object may be used by a user to quickly distinguish trip objects based on status, type, and/or any other attribute of the trip object (e.g., requested trip cost, location, etc.).

Display data for a textual indicator may be displayed in response to data indicative of a cursor hovering over a date element associated with the trip object (step 260). In some implementations, the position of a visual representation of a cursor may be determined relative to one or more data elements of the calendar feature. If the position of the cursor is over a date element associated with a trip object, a textual indicator may be displayed. The textual indicator may include information on the trip title, trip purpose, trip ID, destination and/or travel plan information, and/or the like. In some implementations, the textual indicator may include links to other information and/or that permit the user to edit or otherwise modify the trip object. One example of such a textual indicator is shown as textual indicator 400 in FIG. 5. Of course other textual indicators may be used as well.

FIG. 4 depicts an example user interface 300 having an interactive calendar feature 350 that may be presented to a user. In the example shown, user interface includes representations 310 one or more objects that may be presented in a list format to a user. In the example shown, a number of expense report objects and trip request objects are shown. In some implementations, such objects may be associated with a single trip object that is representative of an entire trip.

Calendar feature 350 of the present example is shown with multiple date elements 352 representative of a day of the calendar. A first set of date elements 354 are associated with an object and are displayed with a visual indicator, in this example a grey shading and/or a color, to indicate an attribute of the associated object. The attribute may be a status of a trip object (e.g., in an expense report stage, a draft status of the expense report stage, or the like), a type of the trip (e.g., international, local, marketing, business, or the like), and/or any other attribute. A second set of date elements 356 are associated with another object and displayed with a second visual indicator, such as another shade of grey and/or any other color, to indicate a second attribute of the associated object. Similarly, a third set of date elements 358 are associated with yet another object and displayed with a third visual indicator, such as another further shade of grey and/or any other color, to indicate a third attribute of the associated object.

In the present example, a user may select one or more of the date elements 352 to create an object, such as a trip object. As discussed above, the object may be automatically created on selection of the date elements or a secondary action (e.g., right-clicking, pressing a key, selecting a button, and/or combinations thereof) may be performed to create the object. Creation of the object may, in some implementations, cause a user interface to be provided to a user for modifying, editing, and/or otherwise interacting with the created object. For example, the user interface may be automatically provided after creating the trip object. In some implementations, the user interface may be a separate page and/or a window having one or more fields for entering information about the object (e.g., in the case of a trip request, the proposed location, cost, etc.). Of course other user interfaces and/or other ways of modifying the object may be provided as well.

FIG. 5 depicts an example textual indicator 450 being displayed in response to a cursor 410 being positioned over a date element, such as those associated with the set of date elements 356. In the present example, textual indicator includes textual information about the object associated with the date element over which the cursor is positioned. In the present example, a trip object is associated with date elements representative of April 17 through 22 for a trip from Boston to New York. The textual information displayed by textual indicator includes the trip title, “Boston to New York,” the dates associated with the trip object, and a trip ID number, 1234. In some implementations, a trip purpose, a travel plan, cost information, and/or any other information associated with the trip object and/or another object may be displayed by textual indicator. In some implementations, the textual indicator may be similar to a “tool tip” type textual indicator. Still other textual indicators may be provided to a user in response to positioning a representation of a cursor over a representation of a date element.

In some implementations, clicking on the date element associated with the trip object or other object may open a viewer or editor to view and/or edit the trip object or other object associated with the selected date element.

These computer programs (e.g., programs, software, software applications or code), include machine instructions for a programmable processor, and can be implemented in a high-level procedural and/or object-oriented programming language, and/or in assembly/machine language. As used herein, the terms “machine-readable medium” and “computer-readable medium” refers to any computer program product, apparatus and/or device (e.g., magnetic discs, optical disks, memory, Programmable Logic Controllers (PLCs) Programmable Logic Devices (PLDs)), used to provide machine instructions and/or data to a programmable processor. A “machine-readable medium” and “computer-readable medium” do not include transitory signals.

To provide for interaction with a user, the systems and techniques described here can be implemented on a computer having a display device (e.g., a CRT (cathode ray tube) or LCD (liquid crystal display) monitor), for displaying information to the user and a keyboard and a pointing device (e.g., a mouse or a trackball), by which the user can provide input to the computer. Other kinds of devices can be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The systems and techniques described here can be implemented in a computing system that includes a back-end component, a middleware component, or a front-end component, or any combination of back-end, middleware, or front-end components. The components of the system may be interconnected by any form or medium of digital data communication (e.g., a communication network). Examples of communication networks include a local area network (“LAN”), a wide area network (“WAN”), and the Internet.

While this specification contains many specific implementation details, these should not be construed as limitations on the scope of any disclosures or of what may be claimed, but rather as descriptions of features specific to particular implementations of particular disclosures. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product embodied on a tangible medium or packaged into multiple software products embodied on tangible media.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein

What is claimed is:

1. A method for creating a business trip, comprising:
outputting, by one or more processing modules, display data to effect display of an interactive calendar feature having one or more date elements;
receiving, by one or more processing modules, data indicative of a selection of one or more date elements of the interactive calendar feature;
receiving, by one or more processing modules, data indicative of a user input for creating a trip object; and
creating, by one or more processing modules, the trip object in response to the received user input, wherein a start date field of the trip object is populated with a first date corresponding to a first date element of the selected one or more date elements and an end date field of the trip object is populated with a second date corresponding to a second date element of the selected one or more date elements in response to the trip object being created.

2. The method of claim 1, further comprising:
outputting, by one or more processing modules, display data to effect display of a visual indicator for the selected one or more date elements.

3. The method of claim 2, wherein the visual indicator comprises a selected color.

4. The method of claim 3, wherein the selected color corresponds to a status of the trip object.

5. The method of claim 3, wherein the selected color corresponds to a type of the trip object.

6. The method of claim 1, further comprising:
outputting, by one or more processing modules, display data to effect display of a textual indicator in response to data indicative of a placement of a cursor for at least a predetermined amount of time over a portion of a computer display corresponding to the selected one or more date elements.

7. The method of claim 6, wherein the textual indicator comprises a trip title of the trip object, a trip purpose of the trip object, or a trip ID of the trip object.

8. The method of claim 1, further comprising:
providing, by one or more processing modules, a user interface for modifying the trip object.

9. The method of claim 8, wherein the step of providing the user interface for modifying the trip object is provided after creating the trip object.

10. A tangible computer-readable storage medium having instructions to create a business trip, the instructions comprising instructions to:
output display data to effect display of an interactive calendar feature having one or more date elements, wherein a first date element is associated with a first trip object, wherein the first trip object has a first attribute;
output display data to effect display of a first visual indicator for the first date element, wherein the first visual indicator is associated with the first attribute;
receive data indicative of a selection of one or more date elements of the interactive calendar feature; and
create a second trip object if the selected one or more date elements do not include the first date element, wherein a start date field of the second trip object is populated with a first date corresponding to a start date element of the selected one or more date elements and an end date field of the second trip object is populated with a second date corresponding to an end date element of the selected one or more date elements in response to the second trip object being created.

11. The tangible computer-readable storage medium of claim 10, wherein the second trip object has a second attribute, the instructions further comprising instructions to:
output display data to effect display of a second visual indicator for the selected one or more date elements, wherein the second visual indicator is associated with the second attribute.

12. The tangible computer-readable storage medium of claim 11, wherein the first visual indicator comprises a first selected color associated with the first attribute, wherein the second visual indicator comprises a second selected color associated with the second attribute.

13. The tangible computer-readable storage medium of claim 11, wherein the first attribute corresponds to a first status of the first trip object and the second attribute corresponds to a second status of the second trip object, wherein the first status and the second status are different.

14. The tangible computer-readable storage medium of claim 11, wherein the first attribute corresponds to a first trip type and the second attribute corresponds to a second trip type.

15. The tangible computer-readable storage medium of claim 10, the instructions further comprising instructions to:
output display data to effect display of a textual indicator in response to data indicative of a placement of a cursor for at least a predetermined amount of time over a portion of a computer display corresponding to the first date element.

16. The tangible computer-readable storage medium of claim 15, wherein the textual indicator comprises a trip title of the first trip object, a trip purpose of the first trip object, or a trip ID of the first trip object.

17. A system comprising:
a tangible computer-readable storage device comprising instructions; and
one or more processors coupled to the tangible computer-readable storage device and configured to execute the instructions to perform operations comprising:
outputting display data to effect display of an interactive calendar feature having one or more date elements,
receiving data indicative of a selection of one or more date elements of the interactive calendar feature,
receiving data indicative of a user input,
creating a trip object in response to the received user input, wherein a start date field of the trip object is populated with a first date corresponding to a first date element of the selected one or more date elements and an end date field of the trip object is populated with a second date corresponding to a second date element of the selected one or more date elements in response to the trip object being created, outputting display data to effect display of a visual indicator for the one or more date elements, and
outputting display data to effect display of a textual indicator in response to data indicative of a placement of a cursor for at least a predetermined amount of time over a portion of a computer display corresponding to the one or more date elements.

18. The system of claim 17, wherein the visual indicator comprises a selected color corresponding to a status of the trip object.

19. The system of claim 17, wherein the visual indicator comprises a selected color corresponding to a type of the trip object.

20. The system of claim 17, wherein the textual indicator comprises a trip title of the trip object, a trip purpose of the trip object, or a trip ID of the trip object.
